(19) United States
(12) Patent Application Publication
(10) Pub. No.: US 2007/0153324 A1
(43) Pub. Date: Jul. 5, 2007

(54) EXTENSIBLE DRIVER

(76) Inventors: Manoj Verma, Gurgaon (IN); Vikas DOGRA, Thousand Oaks, CA (US); Ashutosh Gjiare, Noida (IN); Sanjay Wangoo, Fremont, CA (US); George Koppich, Palos Verdes Estates, CA (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/623,987

(22) Filed: Jan. 17, 2007

Related U.S. Application Data
(63) Continuation-in-part of application No. 10/126,718, filed on Apr. 19, 2002, now abandoned.

(51) Int. Cl. G06F 3/12

(52) U.S. Cl. 358/1.15; 358/1.13

(57) ABSTRACT

The subject application is directed to a system and method for generating an electronic document for transmission to multiple destinations. An electronic document file is received from a document output driver as well as destination data for transmitting the electronic document file to a plurality of destinations. Job attribute data for each of the destinations are also received and a job language file is generated in accordance with the destination data and the job attribute data. The job language file is appended to the electronic document file and the electronic document file with the appended job language file is communicated to the plurality of output destinations in accordance with the appended job language file. The electronic document file is then processed at each output destination in accordance with the appended job language file.

### CROSS-REFERENCE TO RELATED APPLICATIONS

This application is a Continuation-In-Part of U.S. patent application Ser. No. 10/126,718, filed Apr. 19, 2002 entitled, “EXTENSIBLE DRIVER”, the entirety of which is incorporated herein.

### BACKGROUND OF THE INVENTION

The subject application is directed generally to the art of document output, and more to particularly, to document distribution. The subject application is particularly advantageous with respect the generation of an electronic document for transmission to multiple destinations.

Typically when sending an output to a device, a driver for that device must be loaded oil the computer workstation that is sending the output. A driver is a software program that enables other programs to work with a particular device without concerning themselves with the specifics of the device's hardware and internal language. In the case where a computer workstation is connected to several devices, a separate device driver is required for each device. In the case of a network where the output devices may be shared, the driver for each device must be loaded on each computer workstation on the network. When the driver software is updated, then each computer workstation on the network must be upgraded which can be a time consuming administrative task, especially on large networks.

It is often desirable to send an output to multiple destinations. Often the destinations are different devices, such as a facsimile device, an electronic mail server, a copying device, and printer. Normally, a user at a computer workstation would have to manually send the output to each device as each device has a different driver and requires different input parameters to direct the output. For example, a facsimile machine typically needs the telephone number of the destination, a network printer may need information for a cover page, and an electronic mail server may need the electronic mail address of the recipients.

### SUMMARY OF THE INVENTION

In accordance with one embodiment of the subject application, there is provided a system and method for document output.

Further, in accordance with one embodiment of the subject application, there is provided a system and method for document distribution.

Still further, in accordance with one embodiment of the subject application, there is provided a system and method for generating an electronic document for transmission to multiple destinations.

Further, in accordance with one embodiment of the subject application, there is provided a document output system. The system comprises means adapted for receiving an electronic document output from an associated document output driver. The system also comprises means adapted for receiving, from an associated user, destination data representative of a plurality of output destinations for the electronic document. The system includes means adapted for receiving job attribute data associated with received destination data and means adapted for generating a job language file corresponding to received destination data and received job attribute data. The system further includes means adapted for appending the job language file to the electronic document file and means adapted for communicating the electronic document file and appended job language file to an associated server for communication to a plurality of output destinations in accordance with the job language file. The system further comprises means adapted for processing the electronic document at each of the plurality of output destinations in accordance with the job language file appended thereto.

In one embodiment of the subject application, the output destinations arc selected from the group consisting of a printing device, a copying device, a facsimile device, and an electronic mail server.

In another embodiment of the subject application, the job attribute data is received via a system registry of an associated document processing device. In accordance with one embodiment of the subject application, the job attribute data is stored as a dynamic link library on the system registry.

In a further embodiment of the subject application, a job language file is generated for each of the plurality of output destinations. In an additional embodiment, the job language file is a print job language file.

Still further, in accordance with one embodiment of the subject application, there is provided a method for generating an electronic document for transmission to multiple destinations in accordance with the system as set forth above.

Still other advantages, aspects and features of the subject application will become readily apparent to those skilled in the art from the following description wherein there is shownl and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for generating an electronic document for transmission to multiple destinations according to one embodiment of the subject application:

FIG. 2 is a block diagram illustrating a workstation for use in the system for generating an electronic document for transmission to multiple destinations according to one embodiment of the subject application;

FIG. 3 is a block diagram illustrating a server for use in the system for generating an electronic document for transmission to multiple destinations according to one embodiment of the subject application;

FIG. 4 is a block diagram illustrating controller hardware for use in the system for generating an electronic document for transmission to multiple destinations accordingy to one embodiment of the subject application;

FIG. 5 is a functional diagram illustrating the controller for use in the system for generating an electronic document for transmission to multiple destinations according to one embodiment of the subject application;

FIG. 6 is a flowchart illustrating a method for generating an electronic document for transmission to multiple destinations according to one embodiment of the subject application:

FIG. 7 is a flowchart illustrating a method for generating an electronic document for transmission to multiple destinations from a user device perspective according to one embodiment of the subject application; and

FIG. 8 is a flowchart illustrating a method for generating an electronic document for transmission to multiple destinations from a server perspective according to one embodiment of the subject application.

### DETAILED DESCRIPTION OF THE PREFERRED EMBODIMENT

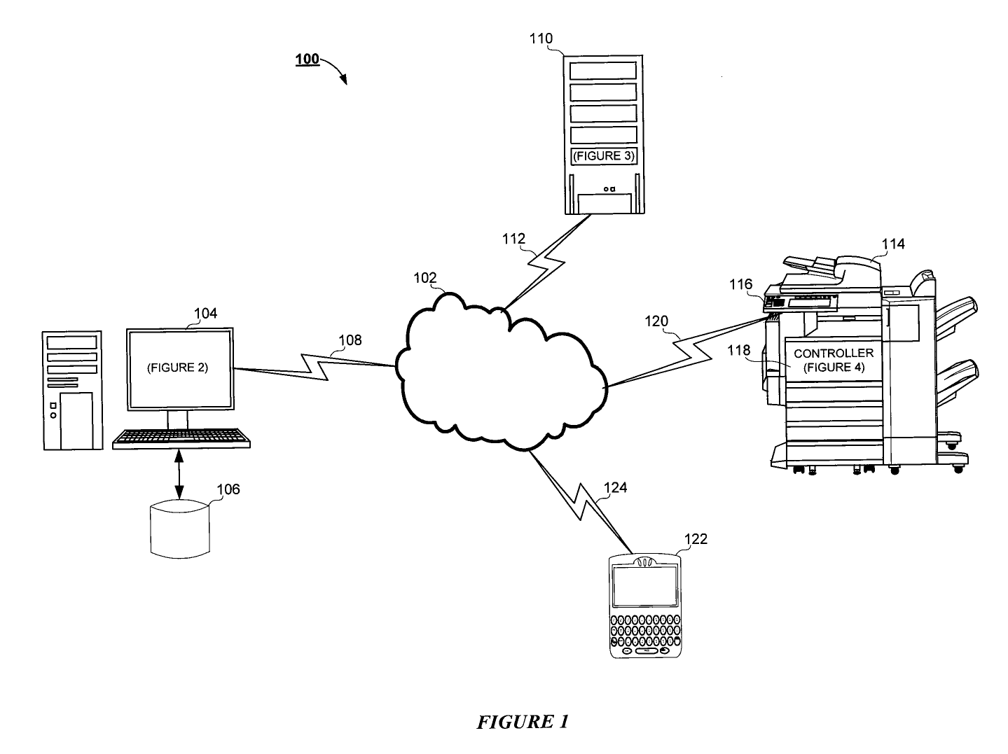

The subject application is directed to a system and method for document Output and distribution. In particular, the subject application is directed to a system and method for generating an electronic document for transmission to multiple destinations. It will become apparent to those skilled in the art that the system and method described herein are suitably adapted to a plurality of varying electronic fields employing device drivers, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for generating an electronic document for transmission to multiple destinations in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

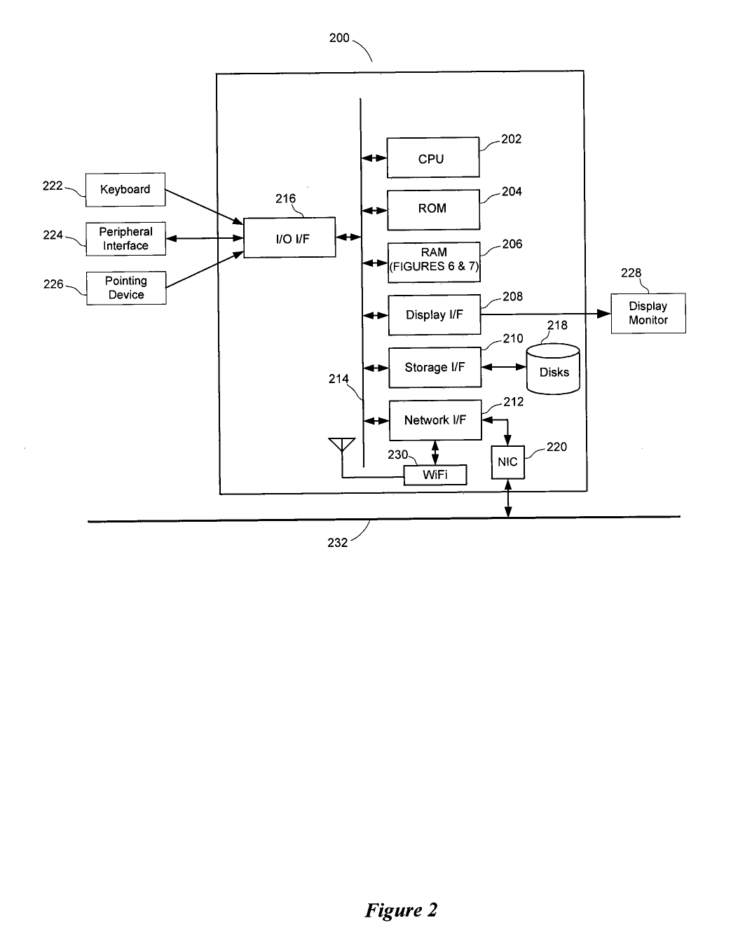

The system 100 illustrated in FIG. 1 further depicts a workstation 104, in data communication with the computer network 102 via a communications link 108. It will be appreciated by those skilled in the art that the workstation 104 is shown in FIG. 1 for illustration purposes only. As will be understood by those skilled in the art, the workstation 104 is representative of any personal computing or user device known in the art, including, for example and without limitation, a laptop computer, a personal computer, a personal data assistant, a web-enabled cellular telephone, a smart phone, a proprietary network device, or other web-enabled electronic device. The communications link 108 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network or any suitable wireless data transmission system, or wired communications known in the art. Preferably, the workstation 104 is suitably adapted to generate and transmit electronic documents, document processing instructions, user interface modifications, upgrades, updates, personalization data, or the like, to a document processing device 104, a document managment system server, or any other similar device coupled to the computer network 102. The functioning of the workstation 104 will better be understood in conjunction with the block diagram illustrated in FIG. 2, explained in greater detail below.

Communicatively coupled to the workstation 104 is a data storage device 106. In accordance with the preferred embodiment of the subject application, the data storage device 106 is any mass storage device known in the art including, for example and without limitation, magnetic storage drives, a hard disk drive, optical storage devices, flash memory devices, or any suitable combination thereof. In the preferred embodiment, the data storage device 106 is suitably adapted to store document data, image data, electronic database data, applications, programs, or the like. It will be appreciated by those skilled in the art that while illustrated in FIG. 1 as being a separate component of the system 100, the data storage device 106 is capable of being implemented as internal storage component of the workstation 104, such as, for example and without limitation, an internal hard disk drive, or the like. In accordance with one embodiment of the subject application, the data storage device 106 includes an operating system having a system registry, such as a WINDOWS-based operating system produced by the MICROSOFT CORPORATION. In such an embodiment, the data storage device 106 includes one or more graphical user interface dynamic link libraries which provide details and specifics. such as job attributes, of output destinations available to the workstation 104 for document output operations, as set forth in greater detail below.

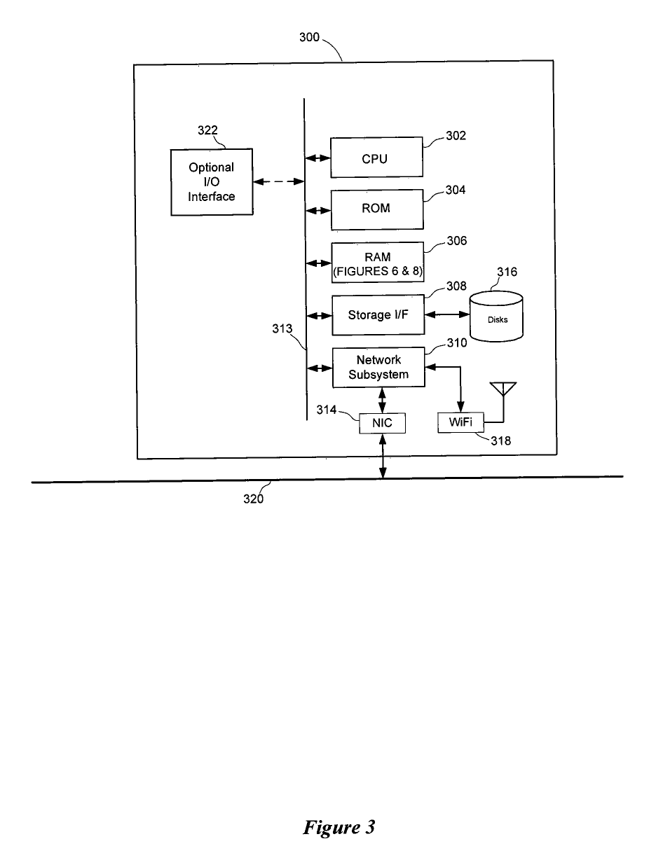

The system 100 of FIG. 1 further includes a document management system server 110, functioning to facilitate the access, storage, and management of a plurality of devices and documents via the computer network 102 over the communications link 112. According to one embodiment of the subject application, the communications link 112 is capable of securely transmitting and receiving communications via the computer network 102. As will be understood by those skilled in the art, suitable communications links include, for example and to without limitation, 802.11a, 802.11b, 802.11g, 802.11(x), Bluetooth, WiMax, infrared, optical, a proprietary communications network, the public switched telephone network, or any suitable wireless data transmission system, or wired communications known in the art. Preferably, the server 110 is suitably adapted to receive and process a variety of requests received via the computer network 102, including, for example and without limitation, document routing requests, document output requests, or the like. In accordance with one embodiment of the subject application, the server 110 is capable of receiving a print file including a header, which header contains a destination for the document, specific job attributes, and the like. As will be appreciated by those skilled in the art, the server 110 is further capable of communicating document data via the computer network 102 to a plurality of devices, such as, for example and without limitation, a computer workstation, a smart phone, a portable data assistant, a document processing device, a facsimile machine, a printer, or the like. The functioning of the management server 110 will better be understood in conjunction with the block diagram illustrated in FIG. 3, explained in greater detail below.

As shown in FIG. 1, the system 100 also illustrates a document processing device 114, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 114 is suitably adapted to provide remote document processing services to external or network devices. Preferably, the document processing device 114 includes hardware, software, and any suitable combination thereof, configured to interact with an associated user, a networked device, or the like.

According to one embodiment of the subject application, the document processing device 114 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 114 further includes an associated user interface 116, such as a touch-screen, LCD display, touch-panel, alpha-numeric keypad, or the like, via which an associated user is able to interact directly with the document processing device 114. In accordance with the preferred embodiment of the subject application, the user interface 116 is advantageously used to communicate information to the associated user and receive selections from the associated user. The skilled artisan will appreciate that the user interface 116 comprises various components, suitably adapted to present data to the associated user, as are known in the art. In accordance with one embodiment of the subject application, the user interface 116 comprises a display, suitably adapted to display one or more graphical elements, text data, images, or the like, to an associated user, receive input from the associated user, and communicate the same to a backend component. such as a controller 118, as explained in greater detail below. Preferably, the document processing device 114 is communicatively coupled to the computer network 102 via a suitable communications link 120. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

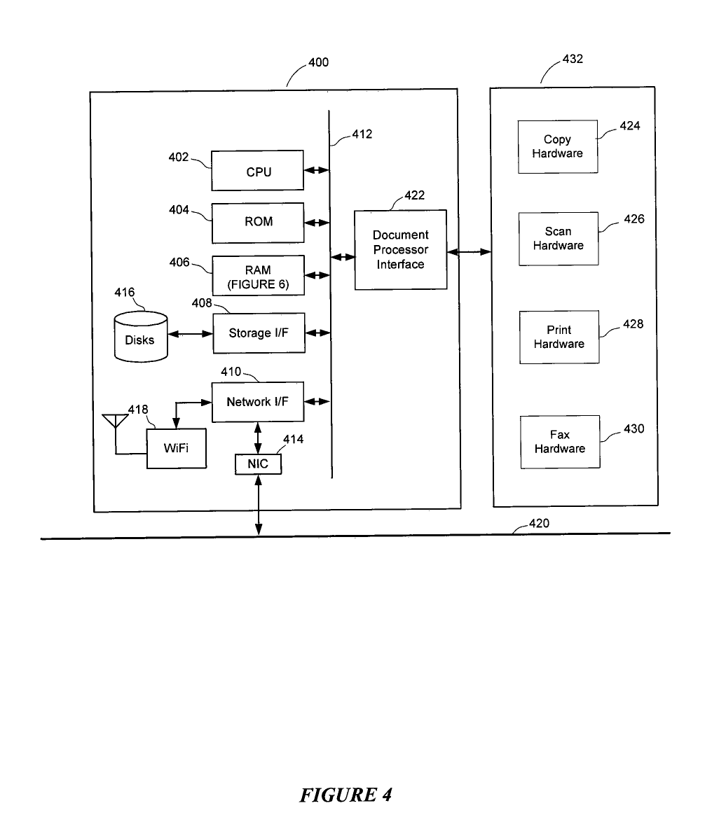

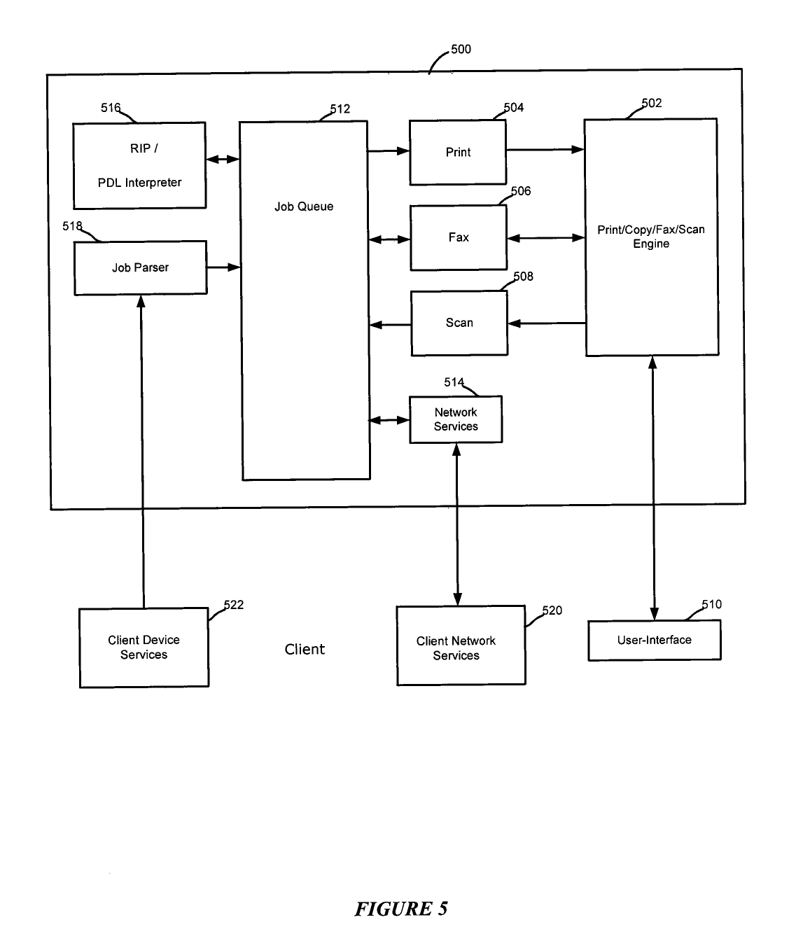

In accordance with one embodiment of the subject application, the document processing device 114 further incorporates a backend component, designated as the controller 118, suitably adapted to facilitate the operations of the document processing device 114, as will be understood by those skilled in the art. Preferably, the controller 118 is embodied as hardware, software, or ally suitable combination thereof, configured to control the operations of the associated document processing device 114, facilitate the display of images via the user interface 116, direct the manipulation of electronic image data, and the like. For purposes of explanation, the controller 118 is used to refer to any myriad of components associated with the document processing device 114, including hardware, software, or combinations thereof, functioning to perform, cause to be performed, control, or otherwise direct the methodologies described hereinafter. It will be understood by those skilled in the art that the methodologies described with respect to the controller 118 are capable of being performed by any general purpose computing system, known in the art, and thus the controller 118 is representative of such a general computing device and is intended as such when used hereinafter. Furthermore, the use of the controller 118 hereinafter is for the example embodiment only, and other embodiments, which will be apparent to one skilled in the art, are capable of employing the system and method for generating an electronic document for transmission to multiple destinations of the subject application. The functioning of the controller 118 will better be understood in conjunction with the block diagrams illustrated in FIGS. 4 and 5, explained in greater detail below.

The system 100 of FIG. 1 further illustrates a wireless handheld device 122 in data communication with the computer network 102 via a suitable communications link 124. As will to be appreciated by those skilled in the art, suitable communications links include, for example and without limitation, a proprietary communications network, the public switched telephone network, infrared, WiMax, 802.11a, 802.11b, 802.11g, 802.11(x), optical. Bluetooth, or any other suitable wired or wireless data transmission communications known in the art. Preferably, the handheld device 122 is suitably adapted to send and receive data communications, such as, for example and without limitation, electronic mail, SMS text messaging, numerical pages, voice communications, and the like. In accordance with one embodiment of the subject application. the handheld device 122 is capable of receiving an electronic mail message sent by the workstation 104 via the server 110.

Turning now to FIG. 2, illustrated is a hardware diagram of a suitable workstation 200 (shown in FIG. 1 as the workstation 104) for use in connection with the subject system. A suitable workstation includes a processor unit 202 which is advantageously placed in data communication with read only memory 204, suitably non-volatile read only memory, volatile read only memory or a combination thereof, random access memory 206, display interface 208, storage interface 210, and network interface 212. In a preferred embodiment, interface to the foregoing modules is suitably accomplished via a bus 214.

The read only memory 204 suitably includes firmware, such as static data or fixed instructions, such as BIOS, system functions, configuration data, and other routines used for operation of the workstation 200 via CPU 202.

The random access memory 206 provides a storage area for data and instructions associated with applications and data handling accomplished by the processor 202.

The display interface 208 receives data or instructions from other components on the bus 214, which data is specific to generating a display to facilitate a user interface. The display interface 208 suitably provides output to a display terminal 226, suitably a video display device such as a monitor, LCD, plasma, or any other suitable visual output device as will be appreciated by one of ordinary skill in the art.

The storage interface 210 suitably provides a mechanism for non-volatile, bulk or long term storage of data or instructions in the workstation 200. The storage interface 210 suitably uses a storage mechanism, such as storage 218, suitably comprised of a disk, tape, CD, DVD, or other relatively higher capacity addressable or serial storage medium.

The network interface 212 suitably communicates to at least one other network interface. shown as network interface 220, such as a network interface card, and wireless network interface 230, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitaable wireless network system, as will be appreciated by on of ordinary skill in the art. In the illustration, the network interface 220 is interconnected for data interchange via a physical network 232, suitably comprised of a local area network, wide area network, or a combination thereof.

An input/output interface 216 in data communication with the bus 214 is suitably connected with an input device 222, such as a keyboard or the like. The input/output interface 216 also suitably provides data output to a peripheral interface 224, such as a USB, universal serial bus output, SCSI, Firewire (IEEE 1394) output, or any other interface as may be appropriate for a selected application. Finally, the input/output interface 216 is suitably in data communication with a pointing device interface 228 for connection with devices, such as a mouse, light pen, touch screen, or the like.

Turning now to FIG. 3, illustrated is a representative architecture of a suitable server 300 (shown in FIG. 1 as the management server 110) on which operations of the subject system are completed. Included is a processor 302, suitably comprised of a central processor unit. However, it will be appreciated that processor 302 may advantageously be composed of multiple processors working in concert with one another as will be appreciated by one of ordinary skill in the art. Also included is a non-volatile or read only memory 304 which is advantageously used for static or fixed data or instructions, such as BIOS functions, systems functions, system configuration, and other routines or data used for operation of the server 300.

Also included in the server 300 is random access memory 306, suitably formed of dynamic random access memory, static random access memory, or any other suitable, addressable memory system. Random access memory provides a storage area for data instructions associated with applications and data handling accomplished by the processor 302.

A storage interface 308 suitably provides a mechanism for volatile, bulk or long term storage of data associated with the server 300. The storage interface 308 suitably uses bulk storage, such as any suitable addressable or serial storage, such as a disk, optical, tape drive and the like as shown as 316, as well as any suitable storage medium as will be appreciated by one of ordinary skill in the art.

A network interface subsystem 310 suitably routes input and output from an associated network allowing the server 300 to communicate to other devices. The network interface subsystem 310 suitably interfaces with one or more connections with external devices to the server 300. By way of example, illustrated is at least one network interface card 314 for data communication with fixed or wired networks, such as Ethernet, token ring, and the like, and a wireless interface 318, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 314 is interconnected for data interchange via a physical network 320, suitably comprised of a local area network, wide area network, or a combination thereof.

Data communication between the processor 302, read only memory 304, random access memory 306, storage interface 308 and the network subsystem 310 is suitably accomplished via a bus data transfer mechanism, such as illustrated by bus 312.

Suitable executable instructions on the server 300 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 322 as will be appreciated by one of ordinary skill in the art.

Turning now to FIG. 4, illustrated is a representative architecture of a suitable backend component, i.e., the controller 400, shown in FIG. 1 as the controller 118, on which operations of the subject system 100 are completed. The skilled artisan will understand that the controller 118 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable. addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 114, which includes the controller 400 of FIG. 4, (shown in FIG. 1 as the controller 118) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodimiient. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

In operation, an electronic document output is received from an associated document output driver. Destination data is then received from an associated user representing a plurality of output destinations for the electronic document. Job attribute data is then received associated with the received destination data. A job language file is then generated corresponding to the received destination data and the received job attributed data. The job language file is then appended to the electronic document file. The electronic document file with the appended job language file is then communicated to an associated server. Based on the job language file, the server communicates the received electronic document file to the plurality of output destinations in accordance with the destination data of the job language file. The electronic document is their processed at each of the plurality of output destinations in accordance with the appended job language file.

In accordance with one example embodiment of the subject application, as seen from the point of view of the workstation 104, graphical user interface dynamic link library files (GUI DLLs) are received corresponding to various output destinations capable of receiving an electronic document file from the workstation 104 via the management server 110. That is, each GUI DLL suitably corresponds to a specific output destination, or device, associated with the computer network 102, e.g., the document processing device 114, the handheld device 122, or the like. In accordance with one embodiment of the subject application, the workstation 104 uses a WINDOWS-based operating system, produced by the Microsoft Corporation, and a suitable driver adapted for generating document processing requests via the management server 110. Further in accordance with such an embodiment, the details and specifics of an output destination are specified by an associated user via a specific destination graphical user interface, which is generated by a corresponding specific GUI DLL program. It will be appreciated by those skilled in the art that the GUI DLLs are capable of being received by the workstation 104 from, for example and without limitation, the management server 110, pushed from a network administrator (not shown), pulled from a suitable web site of available output destinations, via portable storage media compatible with the workstation 104, or the like. It will also be understood by the skilled artisan that while reference is made herein to the workstation 104 employing the driver, such as the document processing device 114, the handheld device, or the like.

The received GUI DLLs are then stored in an associated storage device 106 by the workstation 104. Preferably, the files are stored in a directory readily accessible by the operating system of the workstation 104, such as a hard disk drive. The registry of the operating system resident on the workstation 104 is then amended such that a registry entry is added corresponding to each received GUT DLL. It will be appreciated by those skilled in the art that user devices operating a WINDOWS-based operating system, the entry in the WINDOWS registry points to the respective GUT DLL of each destination. Thus, it will be apparent to those skilled in the art that when a user selects a certain destination, the correct DLL is loaded and the user is provided with the opportunity to enter specific job attributes, as set forth in greater detail below.

The driver, referenced above, resident on the workstation 104 is then invoked, as will be understood by those skilled in the art. Preferably, the driver is invoked at startup of the workstation 104 and is active when the GUI DLLs are received. It will be understood by those skilled in the art, however, that other means for invoking the driver are capable of being employed, for example and without limitation, by logging onto the workstation 104 by an associated user, upon logon of an associated user in a document management network hosted by the management server 110, or the like. The driver then receives an electronic document file corresponding to an electronic document that an associated user desires to have processed at a selected output destination. It will be appreciated by those skilled in the art that suitable document files include, for example and without limitation, word processing files, spreadsheet files, text files, image files, or the like. Upon receipt of the electronic document file, the driver prompts the user to select at least one output destination. In accordance with one embodiment of the subject application, the user is prompted via a graphical user interface on the workstation 104, to select an available output destination, e.g., a destination for which an associated GUI DLL is available. The skilled artisan will appreciate that such a destination also corresponds to an output destination supported by the management server 110 in accordance with the subject application. Suitable available output destinations include, for example and without limitation, the document processing device 114, a dedicated printing device, a dedicated facsimile device, a copying device, an electronic mail server, or the like.

Upon receipt of the first or only output destination from the user, the GUI DLL corresponding to the selected output destination is retrieved in accordance with the registry entry. The retrieved GUI DLL is then used to produce a destination specific graphical user interface, which prompts the user to select job attributes associated with the selected output destination. For example, when the selected output destination is an electronic mail server. Suitable job It) attributes include a recipient address, subject line, carbon-copy addresses, blind carbon-copy addresses, and the like. When the selected output destination is a printer, such as that offered by the document processing device 114, suitable attributes include, for example and without limitation, number of copies, output media, finishing options, and the like. The driver then determines whether any additional output destinations have been selected by the associated user. Preferably, the user indicates additional output destinations via a suitable selection on the graphical user interface displayed by the workstation 104.

When additional output destinations are determined to be desired by the associated user. the driver prompts the user to selected the next output destination, whereupon the corresponding GUI DLL is retrieved and the associated graphical user interface is generated. The skilled artisan will appreciate that the subject application is capable of receiving a plurality of output destinations via the driver graphical user interface simultaneously, thereby informing the driver that multiple output destinations have been selected. Thus, each GUI DLL is loaded and the user specifies corresponding job attributes associated with each output destination. Once all output destination job attributes have been selected by the associated user, or when no further output destinations require user job attribute input, the output destination(s) and associated job attributes are stored as print job language commands in a job language file. According to one embodiment of the subject application, the job attributes corresponding to each selected output destination are stored in a single job language file. In accordance with an alternate embodiment of the subject application, a job language file is generated for each specific output destination, resulting in a plurality of job language files corresponding to a plurality of selected output destinations. The generated job language file, or corresponding number of job language files, are then appended by the driver as a header, or headers, to the received electronic document file and communicated to the management server 110 via the computer network 102 for further operations.

In accordance with another example embodiment of the subject application, as seen from the point of view of the management server 110, an electronic document file with an appended job language file is received from the workstation 104 via the computer network 102. The Job language file is then read, or parsed, by the management server 110. The print job language commands read from the job language file are then interpreted by the management server 110 so as to determine the output destinations associated with the received electronic document file. Once these destinations have been determined, the management server 110 communicates the electronic document file and associated job attributes to the designated output destinations. In accordance with one embodiment of the subject application, each output destination receives the electronic document file and the job attributes specific to that output destination from the management server 110. Thereafter, the output destinations process the electronic document in accordance with their specific job attributes.

For example, when the selected output destination is an electronic mail server, the management server 110 communicates the electronic document file, along with job attributes specifying the recipient to the mail server, which communicates the electronic mail to the recipient, e.g., the handheld device 122. As an additional example, when the output destination is a facsimile device, such as that offered by the document processing device 114, the electronic document file is communicated by the management server 110 to the document processing device 114, along with corresponding job attributes, e.g., recipient name, telephone number, or the like. Thereafter, the document processing device 114 receives the electronic document file and processes the document file in accordance with the received job attributes. In this case, the document processing device 114 generates a facsimile message inclusive of the electronic document and transmits the message to the recipient at the telephone number specified in the job attributes.

The skilled artisan will appreciate that the subject application is further capable of facilitating the addition of new output destinations without requiring modifications to the underlying driver. That is, the process whereby new output destinations are added involves the addition of another entry to the WINDOWS registry and a new GUI DLL.

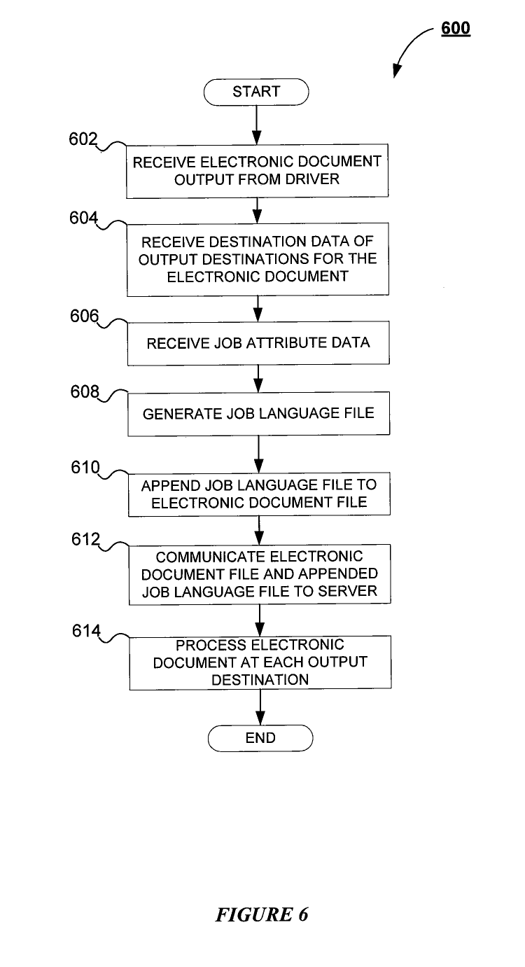

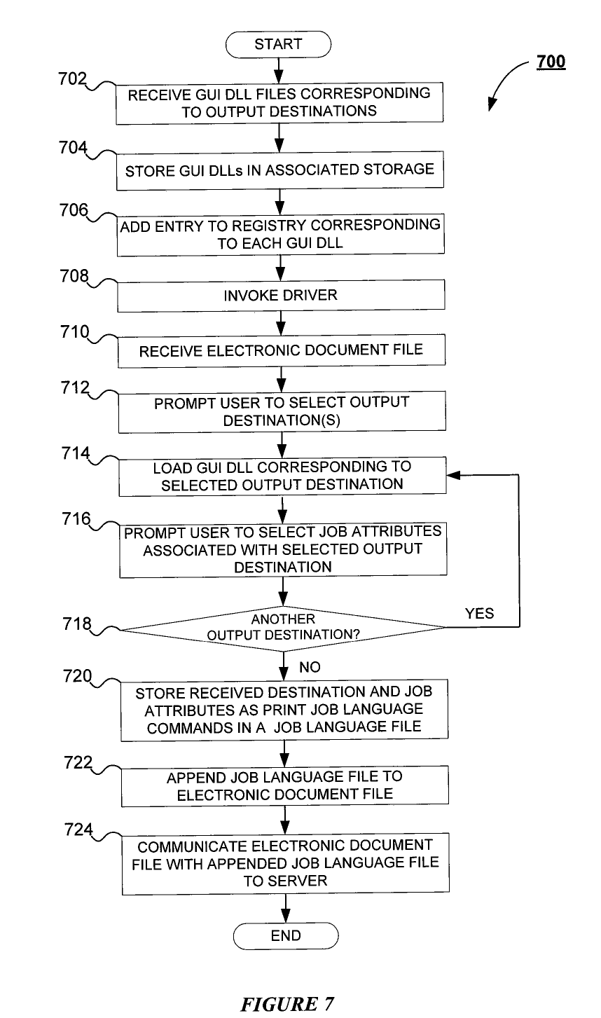

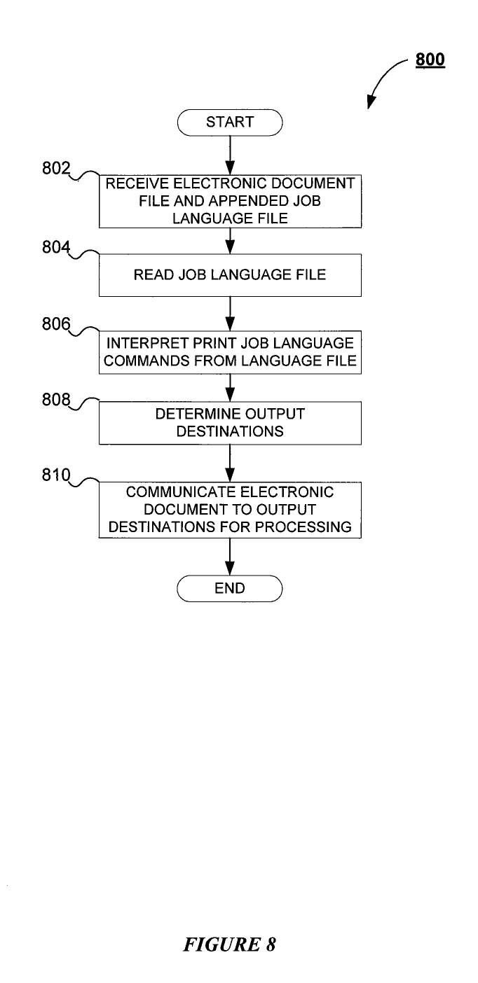

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6. FIG. 7, and FIG. 8. Turning now to FIG. 6, there is shown a flowchart 600 illustrating a method for generating an electronic document for transmission to multiple destinations in accordance with one embodiment of the subject application. Beginning at step 602, electronic document output is received from a driver resident on the workstation 104. It will be appreciated by those skilled in the art that the use of the workstation 104 herein is for example purposes only, and the driver is capable of being implemented on the document processing device 114, the to handheld device 122, or any other networked computing device. Preferably, the driver is a generic driver, as will be appreciated by those skilled in the art. At step 604, the driver associated with the workstation 104 receives destination data from an associated user representing one or more output destinations for the electronic document. In accordance with one embodiment of the subject application, the output destinations include, for example and without limitation, a printing device, a copying device, a facsimile device, an electronic mail server, and the like.

Job attribute data is then received at step 606. According to one embodiment of the subject application, the job attribute data is received via a system registry of an associated document processing device. As will be understood by those skilled in the art, the workstation 104, the document processing device 114, and the handheld device 122, shown in FIG. 1, are each capable of processing electronic documents, ergo each is capable of functioning as a document processing device as used in the description of the method embodied in the flowchart 600 of FIG. 6. In addition thereto, the skilled artisan will appreciate that the system registry corresponds to the registry associated with a WINDOWS-based operating system, such as those produced by MICROSOFT CORPORATION. In accordance with a preferred embodiment of the subject application, the job attribute data is capable of being stored as a dynamic link library (DLL) in association with the system registry. Suitable job attribute data includes, for example and without limitation, with respect to an electronic mail server destination, a recipient, copied recipients, subject, body, and the like, with respect to a web posting, a title and a comment, with respect to a facsimile device, a recipient, a facsimile telephone number, a number of pages, and the like, etc.

The driver then generates, at step 608, a job language file corresponding to the received destination data and the received job attribute data. In accordance with one embodiment of the subject application, the job attributes for each output destination are stored in a single job language file. In accordance with an alternate embodiment ol the subject application, a job language file is generated for each specific output destination, resulting in a plurality of job language files corresponding to a plurality of selected output destinations. The job language file is then appended to the electronic document file at step 610. The electronic document file with appended job language file is then communicated at step 612 to the management server 110 from the workstation 104. Preferably, the job language file is appended as a header associated with the electronic document containing print job language commands corresponding to the selected destinations and associated job attributes. The management server 110 then facilitates the communication of the electronic document with associated job attributes to the designated output destinations, whereupon the electronic document is processed at each output destination at step 614.

Referring now to FIG. 7, there is shown a flowchart 700 illustrating a method for generating an electronic document for transmission to multiple destinations from a workstation, or user device, perspective in accordance with one embodiment of the subject application. Operations described in FIG. 7 begin at step 702, whereupon one or more graphiical user interface dynamic link library (GUI DLL) files are received at the workstation 104 corresponding to one or more output destinations. In accordance with the embodiment described in FIG. 7, the workstation 104 employs a WINDOWS-based operating system, produced by the MICROSOFT CORPORATION, and a suitable driver adapted for generating document processing requests via the management server 110. Preferably each GUI DLL suitably corresponds to a specific output destination, or device, associated with the computer network 102, e.g., the document processing device 114, the handheld device 122, or the like. Furthermore, the details and specifics of an output destination are specified by an associated user via a specific destination graphical user interface, which is produced by a corresponding specific GUI DLL program. Receipt of the GUI DLL files is accomplished by the workstation 104, or other suitable document processing device, via, for example and without limitation, pushed out by a network administrator, downloaded by the user from the manageement server 110, received via a portable storage media, received as an electronic mail message attachment, or the like.

The GUI DLL files are then stored in an associated storage device 106 at step 704. In accordance with one embodiment of the subject application, the GUI DLL files are stored in directories readily accessible by the operating system associated with the workstation 104. At step 706, the registry of the operating system on the workstation 104 is modified such that entries are added corresponding to each received GUI DLL file.

The driver, referenced above, resident on the workstation 104 is then invoked at step 708, as will be understood by those skilled in the art. Preferably, the driver is invoked at startup of the workstation 104 and is active when the GUI DLLs are received. It will be understood by those skilled in the art, however, that other means for invoking the driver are capable of being employed, for example and without limitation, logon onto the workstation 104 by an associated user, upon logon of an associated user in a document management network hosted by the management server 110, or the like.

At step 710, an electronic document file is received representing an electronic document to be output to a desired output destination. Suitable electronic document files include, for example and without limitation, text files, image files, application-type specific files, word processing files, spreadsheet files, or the like. An associated user is then prompted at step 712 to select one or more output destinations. Preferably, this selection is facilitated via the generation of a graphical user interface on the workstation 104. Suitable available output destinaitions include, for example and without limitation, the document processing device 14, a dedicated printing device, a dedicated facsimile device, a copying device, an electronic mail server, or the like.

Following receipt of the one or more user selected output destination, the GUI DLL corresponding to the first selected output destination is retrieved in accordance with the registry entry and loaded at step 714. It will be appreciated by those skilled in the art that the retrieved GUI DLL is loaded to produce a destination specific graphical user interface. Thus, at Step 716, the user is prompted via the destination specific graphical user interface to select job attributes associated with the selected output destination. A determination is then made at step 718 whether additional output destinations had been selected by the user. When one or more additional output destinations had been selected (at step 712), operations return to step 714, whereupon the GUI DLL corresponding to the next output destination is retrieved in accordance with the registry entry. The user is then prompted at step 716 to select job attributes associated with the selected output destination in accordance with the GUI DLL program that was loaded at step 714.

When no additional output destinations remain, as determined at step 718, flow progresses to step 720, whereupon the received destination data and the associated job attributes for each output destination are stored as print job language commands in a job language file. In accordance with one embodiment of the subject application, the job attributes for each output destination are stored in a single job language file. In accordance with an alternate embodiment of the subject application, a job language file is generated for each specific output destination resulting in a plurality of job language files corresponding to a plurality of selected output destinations. The job language file is then appended to the electronic document file as a heater at step 722. The driver then directs the workstation 104 to communicate the electronic document file with associated header to the management server 110 via the computer network 102 at step 724.

Turning now to FIG. 8, there is shown a flowchart 800 illustrating a method for generating an electronic document for transmission to multiple destinations from a server perspective in accordance with one embodiment of the subject application. The method depicted in the flowchart 800 of FIG. 8 begins at step 802, wherein the management server 110 receives via the computer network 102, an electronic document file from an associated workstation 104. As set forth above, the received electronic document file includes a header containing the print job language commands of the job language file. The skilled artisan will appreciate that the job language file, in addition to the job attribute data, also includes the output destinations selected by the user. Thus, at step 804, the server 110 reads the received job language file from the leader. Thereafter, at step 806, the print job language commands contained in the job language file are interpreted by the management server 110. The management server 110 then determines. at step 808, the output destinations selected by the associated user. The electronic document file and associated job attributes are then communicated by the management server 110 to the designated output destinations at step 810. In accordance with one embodiment of the subject application, each output destination receives the electronic document file and the job attributes specific to that output destination from the management server 110.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A document output system, comprising:
means adapted for receiving an electronic document file output from an associated document output driver;
means adapted for receiving, from an associated user, destination data representative of a plurality of output destinations for the electronic document file;
means adapted for receiving job attribute data associated with received destination data;
means adapted for generating a job language file corresponding to received it destination data and received job attribute data;
means adapted for appending the job language file to the electronic document file;
means adapted for communicating the electronic document file and appended Job language file to an associated server for communication to a plurality of output destinations in accordance with the job language file; and
means adapted for processing the electronic document at each of the plurality of output destinations in accordance with the job language file appended thereto.

2. The document output system of claim 1, wherein the output destinations are selected from the group consisting of a printing device, a copying device, a facsimile device, and an electronic mail server.

3. The document output system of claim 1, wherein the job attribute data is received via a system registry of an associated document processing device.

4. The document output system of claim 3, wherein the job attribute data is stored as a dynamic link library on the system registry.

5. The document output system of claim 1, wherein a job language file is generated for each of the plurality of output destinations.

6. The document output system of claim 1, wherein one job language file is generated for the plurality of output destinations.

7. The document output system of claim 1, wherein the job language file is a print job language file.

8. A method for generating an electronic document for transmission to multiple destinations comprising the steps of:
receiving an electronic document output from an associated document output driver;
receiving, from an associated user, destination data representative of a plurality of output destinations for the electronic document;
receiving job attribute data associated with received destination data;
generating a job language file corresponding to received destination data and received job attribute data;
appending the job language file to the electronic document file;
communicating the electronic document file and appended job language file to an associated server for communication to a plurality of output destinations in accordance with the job language file; and
processing the electronic document at each of the plurality of output destinations in accordance with the job language file appended thereto.

9. The method for generating an electronic document for transmission to multiple destinations of claim 8, wherein the output destinations are selected from the group consisting of a printing device, a copying device, a facsimile device, and an electronic mail server.

10. The method for generating an electronic document for transmission to multiple destinations of claim 8, wherein the job attribute data is received via a system registry of an associated document processing device.

11. The method for generating an electronic document for transmission to multiple destinations of claim 10, wherein the job attribute data is stored as a dynamic link library on the system registry.

12. The method for generating an electronic document for transmission to multiple destinations of claim 8, wherein a job language file is generated for each of the plurality of output destinations.

13. The method for generating an electronic document for transmission to multiple destinations of claim 8, wherein one job language file is generated for the plurality of output destinations.

14. The method for generating an electronic document for transmission to multiple destinations of claim 8, wherein the job language file is a print job language file.

15. A computer-implemented method for generating an electronic document for transmission to multiple destinations comprising the steps of:
receiving an electronic document output from an associated document output driver;
receiving, from an associated user, destination data representative of a plurality of output destinations for the electronic document;
receiving job attribute data associated with received destination data;
generating a job language file corresponding to received destination data and received job attribute data;
appending the job language file to the electronic document file;
communicating the electronic document file and appended job language file to an associated server for communication to a plurality of output destinations in accordance with the job language file; and
processing the electronic document at each of the plurality of output destinations in accordance with the job language file appended thereto.

16. The computer-implemented method for generating an electronic document for transmission to multiple destinations of claim 15, wherein the output destinations are selected from the group consisting of a printing device, a copying device, a facsimile device, and an electronic mail server.

17. The computer-implemented method for generating an electronic document for transmission to multiple destinations of claim 15, wherein the job attribute data is received via a system registry of an associated document processing device.

18. The computer-implemented method for generating an electronic document for transmission to multiple destinations of claim 17, wherein the job attribute data is stored as a dynamic link library on the system registry.

19. The computer-implemented method for generating an electronic document for transmission to multiple destinations of claim 15, wherein a job language file is generated for each of the plurality of output destinations.

20. The computer-implemented method for generating an electronic document for transmission to multiple destinations of claim 15, wherein one job language file is generated for the plurality of output destinations.
